(19) United States
(12) Patent Application Publication
(10) Pub. No.: US 2023/0407439 A1
(43) Pub. Date: Dec. 21, 2023

(54) NICKEL BASED SUPERALLOY WITH HIGH OXIDATION RESISTANCE, HIGH CORROSION RESISTANCE AND GOOD PROCESSABILITY

(71) Applicant: Siemens Energy Global GmbH & Co. KG, Munich, Bayern (DE)

(72) Inventors: Magnus Hasselqvist, Finspong (SE); Zhe Chen, Norrköping (SE); David Gustafsson, Linghem (SE); Frans Palmert, Åby (SE)

(73) Assignee: Siemens Energy Global GmbH & Co. KG, Munich, Bayern (DE)

(21) Appl. No.: 18/035,746

(22) PCT Filed: Oct. 19, 2021
(86) PCT No.: PCT/EP2021/078919

§ 371 Date: May 7, 2023

(30) Foreign Application Priority Data
Nov. 18, 2020 (EP) 20208248.3

(51) Int. Cl. C22C 19/05; C22F 1/10; F01D 5/28

(52) U.S. Cl. CPC C22C 19/056; C22F 1/10; F01D 5/28

(57) ABSTRACT

Nickel based super alloy, which includes at least, (in wt %): Iron (Fe) 1.5%-6.5% especially 3.5%-5.5%; Chrome (Cr) 12.0%-14.0%; Molybdenum (Mo) 1.0%-2.0%; Wolfram (W) 2.0%-5.0%; Aluminum (Al) 5.2%-5.8%; Tantalum (Ta) 5.0%-7.0%; Hafnium (Hf) 1.2%-1.8%; Silicon (Si) 0.005%-0.4%; Carbon (C) 0.005%-0.1%; Nickel (Ni), optionally Cobalt (Co) 0.0%-5.0%; especially at least 1.0 wt % Cobalt (CO); Boron (B) >0.0%-0.02%; especially maximum 0.005%; Zirconium (Zr) >0.0%-0.05%; especially maximum 0.01% 0-0.05%; reactive element(s), especially Yttrium (Y), Cerium (Ce), Dysprosium (Dy), and/or Lanthanum (La).

### CROSS REFERENCE TO RELATED APPLICATIONS

This application is the US National Stage of International Application No. PCT/EP2021/078919 filed 19 Oct. 2021, and claims the benefit thereof. The International Application claims the benefit of European Application No. EP20208248 filed 18 Nov. 2020. All of the applications are incorporated by reference herein in their entirety.

### FIELD OF INVENTION

The invention relates to Nickel-based superalloys with high oxidation resistance, high corrosion resistance and good processability.

### BACKGROUND OF INVENTION

There is always a need to increase the combination of performance, robustness and fuel flexibility of our gas turbines. The key to this is to improve material systems in the hot stage turbine components. Improved robustness requires an improved ability to suppress corrosion and oxidation assisted crack propagation.

A coating cannot by definition protect a crack, hence this implies a need for improved combinations of bare corrosion and oxidation resistance. Higher bond coat temperatures with retained or reduced top coat spallation in TBC (Thermal Barriers Coating) would provide improved component performance. Hence there is a need for new base alloys with improved combinations of bare corrosion and oxidation resistance as well as improved coating compatibility. These alloys must also have useful mechanical properties and processability.

Classical Industrial Gas Turbine (IGT) alloys for turbine blades and vanes such as IN792, IN738LC and PWA1483 score well in corrosion resistance and processability, but less so in terms of oxidation resistance and coating compatibility. Aero alloys such as Alloy247LC and CMSX-4 score well in terms of oxidation resistance and coating compatibility, but less so in terms of corrosion resistance and their small Heat Treatment Windows (HTW) reduce their processability.

New IGT alloys STAL15SX and STAL125 combine the oxidation and coating compatibility of the Aero alloys with the corrosion resistance of the IGT alloys, and, also show larger HTW values than Aero or IGT alloys.

But there is a need to have new IGT alloys with even better coating compatibility and bare oxidation resistance than what have already been designed.

### SUMMARY OF INVENTION

It is therefore the aim of the invention to overcome the problems of the state of the art as listed above and improve Nickel-based superalloys.

The problem is solved by an alloy and a component according to the independent claims.

In the dependent claims further advantages are listed which can be combined arbitrarily with each other to yield further advantages.

CC means a polycrystalline structure, DS means a columnar structure and SX means single crystal structure.

Compared to the current alloys for IGT there is the idea to partly or fully replace Cobalt (Co) by Iron (Fe) and partly replace Tantalum (Ta) by (or by more) Hafnium (Hf) to improve the bare oxidation resistance and the coating compatibility while retaining the large heat treatment window despite the addition of more Hafnium (Hf).

As an example:
The CC alloy STAL125CC has a nominal composition (in wt %) of: Ni-5Co-12.5Cr-1.5Mo-3.5W-5.5A-8Ta-0.5Hf-0.07C-0.015B-0.01Zr; which is transformed into Ni-3Co-4Fe-12.5Cr-1.5Mo-3.5W-5.6A-6Ta-1.5Hf-0.07C-0.015B-0.01Zr.

The Aluminum (Al) activity at 1273K is increased by 49%, while the HTW is increased from 75K to 100K.

The addition of Hafnium (Hf) enables the alloy to be used for CC as well as DS casting. When it diffuses into a bond coat of the substrate it will suppress the rumpling via strengthening of the beta phase, and this will suppress the spallation of the ceramic top coat.

The addition of iron (Fe) will reduce the gamma prime solvus temperature to such an extent that it more than compensates for the reduction in the HTW due to the Hafnium (Hf) addition.

The addition of Iron (Fe) also increases the Aluminum (Al) activity, and this improves the bare oxidation resistance, and, reduces the loss of Aluminum (Al) from the bond coat into the base alloy via interdiffusion, enabling higher bond coat temperatures.

As a further example: If a SX-alloy is tie line scaled to 12.5% Cr by keeping the matrix and particles compositions constant while the fraction of gamma prime phase is increased until the content of Chromium (Cr) has been reduced to 12.5% Cr to improve the creep strength we get: Ni-4.6Co-12.5Cr-0.9Mo-3.7W-5.4Al-9.1Ta-0.1Hf-0.25Si.

With the same type of transformation where Iron (Fe) is added and Hafnium (Hf) increased while Tantalum (Ta) and Cobalt (Co) are reduced we get: Ni-3Co-4Fe-12.5Cr-1.3Mo-3W-5.4Al-6.5Ta-1.5Hf-0.25Si.

The Aluminum (Al) activity at 1273K is increased by 43%.

These are preliminary composition limits for a patent application:

Then there should probably be a few additional refinements resulting in a few preferred embodiments.

Reactive Elements (RE) are some combination of Sulfur neutralizers like Ce, La, Y, Dy, . . . .

The technical inventive step is the use of Iron (Fe) to increase the activity of Aluminum (Al) and the heat treatment window, despite the addition of more Hafnium (Hf) for coating compatibility and improved DS castability.

It will be possible to tolerate higher bond coat temperatures and more frequent cycling. A beneficial side effect is that the HIP/solutioning temperature can be reduced from the 1523K to 1553K used in the New IGT alloys to 1473K (1200° C.) as effect of the reduced gamma prime solvus temperature thanks to additional Iron (Fe). A reduced HIP/solutioning temperature broadens the number of HIP vendors able to do this.

Another beneficial side effect is that Cobalt (Co) is a problematic element in terms of health and safety, and reduced Co levels are thus advantageous.

A further and important advantage is that replacement of Tantalum (Ta) by Hafnium (Hf) decreases the density.

Better components thanks to more design freedom. Easier procurement because of HIP at reduced temperatures.

Advanced laser cladding with fillers having extremely high oxidation resistance and coating compatibility to pre-empt oxidation and spallation of the top coat at ‘tips and edges’ where the temperatures tend to be especially high, i.e. the use of hybrid components.

### DETAILED DESCRIPTION OF INVENTION

The inventive alloy comprises (in wt %):

| | |
|---|---|
| Cobalt (Co) | 0.0-5.0, |
| especially until | 4.0, |
| Iron (Fe) | 1.5-6.5, |
| especially | 2.5-4.5, |
| Chromium (Cr) | 12.0-14.0, |
| Molybdenum (Mo) | 1.0-2.0, |
| especially | 1.1-1.6, |
| Wolfram (W) | 2.0-5.0, |
| especially | 2.5-4.0, |
| Aluminum (Al) | 5.2-5.8, |
| Tantalum (Ta) | 5.0-7.0, |
| especially | 6.0-7.0, |
| Hafnium (Hf) | 1.2-1.8, |
| optionally | |
| Carbon (C) | 0.005-0.1, |
| Silicon (Si) | 0.005-0.4, |
| Boron (B) | >0-0.02, |
| especially | 0.005-0.02, |
| Zirconium (Zr) | >0-0.05, |
| especially | 0.005-0.05, |
| 0.0-0.05 | reactive element(s), |
| | especially Cerium (Ce), Yttrium (Y), |
| | Lanthanum (La), and/or Dysprosium (Dy), Ni based. |

A large blade has a weight larger than 1.0 kg, especially heavier than 1.5 kg.

A small blade has a weight smaller than 1.0 kg, especially smaller than 0.8 kg.

For small or large blades both in a SX structure the alloy comprises 0.1 wt %-0.4 wt % Silicon (Si).

For small and large blades in a CC or DS structure the alloy comprises especially 0.005 wt %-0.015 wt % Silicon (Si).

For small blades in a SX structure the alloy comprises especially 0.005 wt %-0.03 wt % Carbon (C).

For large blades in a SX structure the alloy comprises especially 0.03 wt %-0.07 wt % Carbon (C).

For small and large blades in a CC or DS structure the alloy comprises especially 0.03 wt %-0.1 wt % Carbon (C).

For small blades in a SX structure the alloy comprises especially maximum 0.005 wt % Boron (B).

For large blades in a SX structure the alloy comprises especially 0.005 wt %-0.015 wt % Boron (B).

For small and large blades in a CC or DS structure the alloy comprises 0.005 wt %-0.02 wt % Boron (B).

For small and large blades in a CC or DS structure the alloy comprises 0.005 wt %-0.05 wt % Zirconium (Zr).

For small or large blades in a SX structure the alloy comprises maximum 0.01 wt % Zirconium (Zr).

1.-28. (canceled)

29. A Nickel based super alloy, which comprises at least, especially consists of (in wt %):

| | |
|---|---|
| Iron (Fe) | 1.5-6.5, especially 2.5-4.5, |
| Chromium (Cr) | 12.0-14.0, |
| Molybdenum (Mo) | 1.0-2.0, especially 1.1-1.6, |
| Wolfram (W) | 2.0-5.0, especially 2.5-4.0, |
| Aluminum (Al) | 5.2-5.8, |
| Tantalum (Ta) | 5.0-7.0, especially 6.0-7.0, |
| Hafnium (Hf) | 1.2-1.8, |
| Nickel (Ni), | |
| optionally | |
| Cobalt (Co) | 0.0-5.0, especially 0.0-4.0, |
| Silicon (Si) | 0.005-0.4 |
| Carbon (C) | 0.005-0.1 |
| Boron (B) | >0.0-0.02, especially maximum 0.005, |
| Zirconium (Zr) | >0.0-0.05, especially maximum 0.01, |
| 0-0.05 | reactive element(s), |
| | especially Yttrium (Y), Cerium (Ce), |
| | Dysprosium (Dy), and/or Lanthanum (La). |

30. The Alloy according to claim 29, which comprises
no Cobalt (Co).

31. The Alloy according to claim 29, which comprises
at least 1 wt % Cobalt (Co), especially at least 2.5 wt % cobalt (Co).

32. The Alloy according to claim 29, which comprises
at least 0.005 wt % Boron (B).

33. The Alloy according to claim 29, which comprises
maximum 0.02 wt % Boron (B),
especially maximum 0.015 wt % Boron (B),
very especially maximum 0.005 wt % Boron (B).

34. The Alloy according to claim 29,
which contains no boron (B).

35. The Alloy according to claim 29, which comprises
at least 0.005 wt % Zirconium (Zr).

36. The Alloy according to claim 29, which comprises
at least 0.005% Carbon (C),
especially at least 0.03% Carbon (C).

37. The Alloy according to claim 29, which comprises
maximum 0.1% Carbon (C),
especially maximum 0.07% Carbon (C),
very especially maximum 0.03% Carbon (C).

38. The Alloy according to claim 29, wherein the alloy comprises:
Ni-3Co-4Fe-12.5Cr-1.5Mo-3.5W-5.6Al-6Ta-1.5Hf-0.07C-0.015B-0.01Zr.

39. The Alloy according to claim 29, wherein the alloy comprises:
Ni-3Co-4Fe-12.5Cr-1.3Mo-3W-5.4Al-6.5Ta-1.5Hf-0.25Si.

40. The Alloy according to claim 29, wherein the alloy comprises
no Silicon (Si).

41. The Alloy according to claim 29, wherein the alloy comprises
no Carbon (C), no Boron (B) and/or no Zirconium (Zr).

42. The Alloy according to claim 29, wherein the alloy comprises
Silicon (Si).

43. The Alloy according to claim 29, wherein the alloy comprises
Carbon (C), Boron (B) and/or Zirconium (Zr).

44. A component, especially which is a component for a gas turbine,
which is made of an alloy according to claim 29,

45. The component according to claim 44,
which has a columnar structure (DS) or which has a single crystal structure (SX).

46. The component according to claim 44,
which has a polycrystalline structure (CC).
